(19) United States
(12) Patent Application Publication
(10) Pub. No.: US 2013/0088335 A1
(43) Pub. Date: Apr. 11, 2013

(54) MOBILE DEVICE STAGING WITH RFID TAGS

(71) Applicants: Saravana Babu, Bangalore (IN); Allan Herrod, Mission Viejo, CA (US); Jimmy Joseph, Bangalore (IN); Deepak Khade, Sankeshwar (IN); Vikram Murthy, Bangalore (IN)

(72) Inventors: Saravana Babu, Bangalore (IN); Allan Herrod, Mission Viejo, CA (US); Jimmy Joseph, Bangalore (IN); Deepak Khade, Sankeshwar (IN); Vikram Murthy, Bangalore (IN)

(73) Assignee: Symbol Technologies, Inc., Holtsville, NY (US)

(21) Appl. No.: 13/268,153

(22) Filed: Oct. 7, 2011

(51) Int. Cl. H04Q 5/22

(52) U.S. Cl. 340/10.51

(57) ABSTRACT

A system for staging a mobile device is described. The mobile device includes a processor that executes a software application. A memory stores a unique identifier for the mobile device. The unique hardware identifier is readable by the software application and unreadable by any system that is external to the mobile device. The mobile device also includes a radio frequency identification (RFID) tag associated with the mobile device. The RFID tag stores a unique serial number that is readable by a staging system external to the mobile device and by the software application. The staging system encrypts a staging profile using both the unique serial number and the unique hardware identifier to create a device-specific key. The staging system writes the encrypted staging profile to the RFID tag.

### TECHNICAL FIELD

The invention relates generally to staging a mobile device for use on a network.

### BACKGROUND

In order for an electronic device to properly connect to a network, the device has to initially be configured to be managed and be discovered on the management system. Specifically, the device has to be staged to enable the configuration of the device. Staging is the process of quickly preparing mobile devices to deploy into an enterprise by providing settings to configure connectivity to the enterprise network, to configure access to a deployment server, and to specify the deployment to be performed.

### SUMMARY

In one aspect, the invention is embodied in a mobile device. The mobile device includes a processor that executes a software application. A memory stores a unique identifier for the mobile device. The unique hardware identifier is readable by the software application and unreadable by any system that is external to the mobile device. The mobile device also includes a radio frequency identification (RFID) tag associated with the mobile device. The RFID tag stores a unique serial number that is readable by a staging system external to the mobile device and by the software application. The staging system encrypts a staging profile using both the unique serial number and the unique hardware identifier to create a device-specific key. The staging system writes the encrypted staging profile to the RFID tag.

In one embodiment, the unique hardware identifier is provided to the staging system by a device manufacturer and not from the mobile device. The mobile device can also include a RFID tag reader coupled to the processor. The RFID tag reader can be either integrated or removably attached to the mobile device.

The mobile device can also include a battery that is removably coupled to the mobile device. In one embodiment, the staging profile is writable to the RFID tag when the battery is uncoupled from the mobile device.

In one embodiment, the unique serial number is unalterable by an external device. The mobile device can be contained in a package. The unique serial number can be applied to the package in the form of a barcode symbol. In one embodiment, the staging system includes a barcode reader configured to read the barcode symbol. The staging system compares the serial number from the barcode symbol with the serial number from the RFID tag associated with the mobile device.

In one embodiment, the staging system includes a RFID writer configured to write the encrypted staging profile to the RFID tag associated with the mobile device when the mobile device is positioned in range of the RFID writer.

In another aspect, the invention is embodied in a method for staging a mobile device. The method includes storing a unique hardware identifier in a memory of the mobile device that is readable by a software application executing on a processor of the mobile device and unreadable by a system external to the mobile device. The method further includes reading a unique serial number stored in a radio frequency identification (RFID) tag associated with the mobile device.

A staging profile is encrypted using both the unique serial number and the unique hardware identifier to create a device-specific key. The mobile device having the RFID tag with the unique serial number is then located. The encrypted staging profile is then written to the RFID tag. The encrypted staging profile is decrypted by the using the device-specific key. The mobile device is then staged by applying information in the decrypted staging profile to the mobile device.

In one embodiment, the authenticity of the decrypted staging profile is verified. The method can also include providing the unique hardware identifier to a staging system. In one embodiment, the unique serial number stored in the RFID tag is unalterable by an external device.

The method can also include applying a barcode symbol including the serial number on an external surface of a package containing the mobile device. The barcode symbol can then be read and the serial number from the barcode symbol can be compared with the serial number from the RFID tag associated with the mobile device.

In one embodiment, the method can further include writing the encrypted staging profile to the RFID tag associated with the mobile device when the mobile device is positioned in range of a RFID writer.

In yet another embodiment, the invention is embodied in a mobile device staging arrangement. The arrangement includes a mobile device having a processor for executing a software application. A memory stores a unique hardware identifier for the mobile device. The unique hardware identifier is readable by the software application and unreadable by a system external to the mobile device. A radio frequency identification (RFID) tag associated with the mobile device stores a unique serial number that is readable by a staging system external to the mobile device and the software application.

The arrangement also includes a staging system including a staging device that encrypts a staging profile using both the unique serial number and the unique hardware identifier to create a device-specific key. The staging device writes the encrypted staging profile to the RFID tag associated with the mobile device.

In one embodiment, the unique hardware identifier for a mobile device is provided to the staging system by a device manufacturer separately from the mobile device. The unique serial number is unalterable by an external device. The mobile device can also include battery that can be removably coupled to the mobile device.

In one embodiment, the mobile device is contained within a package. The unique serial number is applied to the package in the form of a barcode symbol. In one embodiment, the staging system can also include a barcode reader configured to read the barcode symbol. The staging system can compare the serial number from the barcode symbol with the serial number from the RFID tag associated with the mobile device.

The staging system can also include a RFID writer configured to write the encrypted staging profile to the RFID tag associated with the mobile device when the mobile device is positioned in range of the RFID writer.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 illustrates a mobile device including an integrated radio-frequency identification (RFID) tag according to an exemplary embodiment.

FIG. 2 illustrates a staging system according to an exemplary embodiment.

FIG. 3 illustrates a pre-staging process for preparing the mobile device of FIG. 1 for connection with a network according to an exemplary embodiment

FIG. 4 illustrates a process to prepare the staging server of FIG. 2 for staging mobile devices according to an exemplary embodiment.

FIG. 5 illustrates a process to prepare the mobile device of FIG. 1 for staging according to an exemplary embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional staging, need not, and are not, described in detail herein.

For example, one conventional approach for staging is using short message service (SMS) messages. In SMS staging, a services platform converts a selected staging profile into a sequence of encrypted SMS messages to the electronic device using one or more carriers. The SMS messages may be delivered to devices via email to SMS gateways provided by the carriers and/or via short message peer-to-peer protocol (SMPP) gateways contracted for with the carriers.

However, with SMS staging, a variety issues may arise. First, information about the device such as a phone number, equipment identification, carrier, etc. is required by an administrator in advance to enable the delivery of a staging profile. Second, depending on the method used to deliver the SMS messages, the messages may be delivered slowly or delayed (e.g., high traffic relegates SMS messages) resulting in a long time for a device to be staged. Third, some methods supported by carriers that deliver SMS messages may be limited. Fourth, depending on the service plan and delivery method, carrier may charge for the delivery of SMS messages to devices.

It is desirable for a staging system to be fully automatic, by which is meant that the device can automatically stage itself under appropriate conditions, without the need for a human user to be involved in the staging. In order to be fully automatic, it is necessary to ensure that a device will not be staged unless it can positively verify that the information used to stage it is valid and was provided by a trusted staging system.

In one embodiment, the invention uses RFID technology and a combination of two factors to perform authentication securely. The two factors include a unique hardware identifier and unique serial number that are built into the device and readable by the staging application installed on the device.

An RFID tag is built into the device such that it is readable by the device itself and by a remote staging system that is external to the device. The unique serial number is unalterably stored in the RFID tag associated with the device and optionally printed on a barcode label on the device and/or a barcode label on the factory packaging containing the device. The unique hardware identifier in not readable by any external system outside of the device, and hence the hardware identifier cannot be automatically determined by an external system. For example, the device manufacturer can deliver to a customer of the device the mappings between the unique hardware identifiers and the unique serial numbers for import into the staging system.

The staging system can locate devices to be staged by reading the associated RFID tags and identifying the devices by reading the unique serial numbers stored on the associated tags. In one embodiment, the staging system can optionally sequence or automate the device staging by reading the unique serial numbers from barcodes positioned on the outer packaging of the device (e.g., as devices to be staged move in the field of view of a barcode scanner on a conveyor belt).

The staging system can encrypt staging information using a key derived from the unique hardware identifier and the unique serial number for each device for which it has been provided with the mappings. In one embodiment, the staging system can store encrypted staging information into the RFID tag associated with the device, without removing the devices from the original packaging, and before the device battery is connected to the device.

The staging application installed and executing in the device will only process staging information read from its associated RFID tag, as determined by its the unique serial number. Additionally, the staging application executing in the device will only process staging information that is encrypted using the key derived from the unique hardware identifier and the unique serial number. The staging application in the device must be certain that the staging information was written by a trusted staging system. The staging application executing in the device can perform staging process automatically when such staging information is available from the trusted staging system.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems and methods of staging mobile devices. In an exemplary embodiment, a system for staging a mobile device includes a staging server for generating a staging profile for the mobile device. The mobile device includes a processor for executing a software application. A memory in the mobile device stores a unique hardware identifier for the mobile device. The unique hardware identifier is readable by the software application and unreadable by a system external to the mobile device. A radio frequency identification (RFID) tag associated with the mobile device stores a unique serial number that is readable by a staging system external to the mobile device and the software application. The staging system includes the staging server that encrypts a staging profile using both the unique serial number and the unique hardware identifier to create a device-specific key. The staging server writes the encrypted staging profile to the RFID tag associated with the mobile device.

By “encrypted”, we mean data which has been rendered unusable, unreadable, or indecipherable to unauthorized individuals through the use of a specific technology or methodology.

The staging system then locates the mobile device having the RFID tag with the unique serial number. The staging system then writes the encrypted staging profile to the RFID tag. The encrypted staging profile is decrypted using the device-specific key. The mobile device is staged by applying information in the decrypted staging profile to the mobile device.

It should be noted that the mobile device being staged is only exemplary. The exemplary embodiments may be used for any electronic device that is configured using an associated RFID tag. Thus, the mobile device as described herein may refer to both mobile electronic devices and stationary electronic devices.

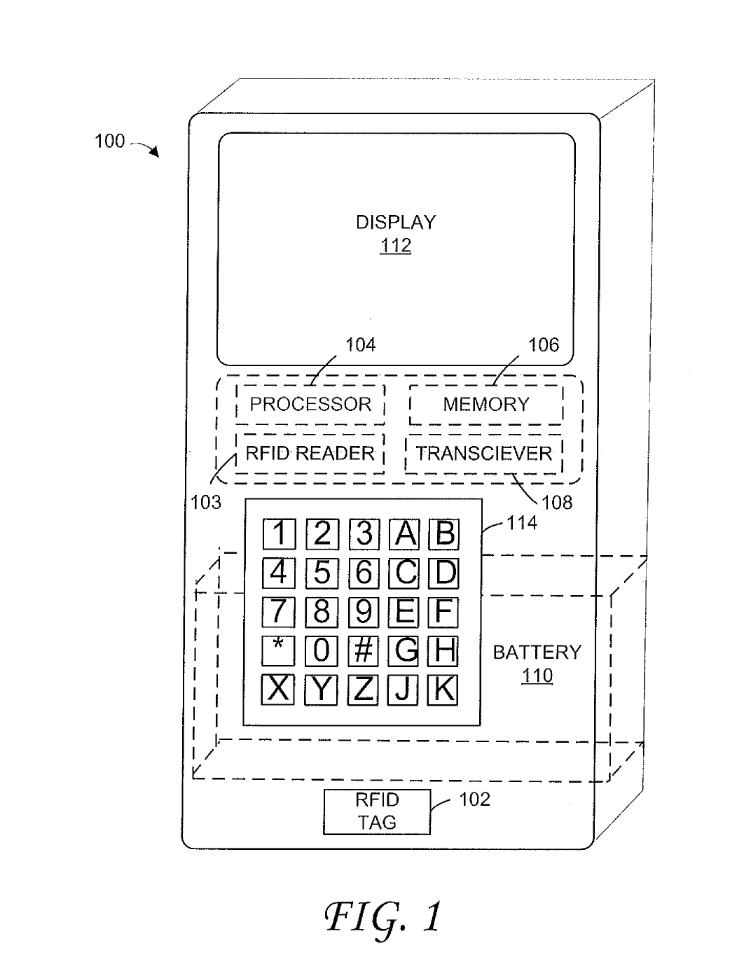

FIG. 1 illustrates a mobile device 100 including an associated integrated radio-frequency identification (RFID) tag 102 according to an exemplary embodiment. The associated RFID tag 102 can be integrated with the mobile device 100, attached to the mobile device 100, or located in the manufacturer's packaging of the mobile device 100. The RFID tag 102 can be a passive tag having no external power supply. The RFID tag 102 can alternatively be an active tag having an external power supply, such as a battery. The RFID tag 102 can include a memory for storing a staging profile for the mobile device 100. The mobile device 102 can also include an RFID reader/writer 103 which allows the mobile device to communicate with the RFID tag 102.

The mobile device 100 can include a processor 104 and a memory 106 for storing software applications for execution on the processor 104. The processor 104 can include one or more microprocessors, microcontrollers, DSPs, state machines, logic circuitry, analog to digital (A/D) converters, hardware digitizers, or any other device or devices that process information based on operational or programming instructions. Such operational or programming instructions are preferably stored in the memory 106. The memory 106 can also store information relating to the mobile device 100 such as user configuration data. The memory 106 can be an IC memory chip containing any form of random access memory (RAM) or read only memory (ROM), a floppy disk, a compact disk (CD) ROM, a hard disk drive, a digital video disk (DVD), a flash memory card or any other medium for storing digital information. Skilled artisans will recognize that when the processor 104 has one or more of its functions performed by a state machine or logic circuitry, the memory 106 containing the corresponding operational instructions may be embedded within the state machine or logic circuitry. Operations performed by the processor 104 are described in detail below.

The mobile device 100 can also include a transceiver 108. The transceiver 108 can include transmitter circuitry and receiver circuitry. The transceiver 108 is configured to connect the mobile device 100 to a network following the staging of the mobile device 100 according to the invention. The mobile device 100 can also include a battery 110 for powering the mobile device 100. The battery 110 can be removably coupled to the mobile device 100.

The mobile device 100 can include a display 112 for displaying information relating to the mobile device 100. The display 112 can be a liquid crystal display and can include touch screen capability. The mobile device 100 can also include a keypad 114 for accepting user input. The mobile device 100 can also include other input/output devices, such as an audio speaker, a microphone, a touchpad or other pointing device, a touch screen and/or any other suitable device that allows a user to interact with the mobile device 100.

Once the mobile device 100 is staged, the transceiver 108 of the mobile device 100 can communicate with a network. The network can be any conventional type of network. For example, the network can be a local area network (LAN), a wireless LAN (WLAN), a virtual LAN (VLAN), a wide area network (WAN), a wireless WAN (WWAN), a virtual WAN (VWAN), a metropolitan area network (MAN), a storage area network (SAN), etc. The network can be configured to support data and voice applications such as Internet capabilities, SMS messages, a telephone functionality, etc. The network can include a variety of network components providing conventional functionalities.

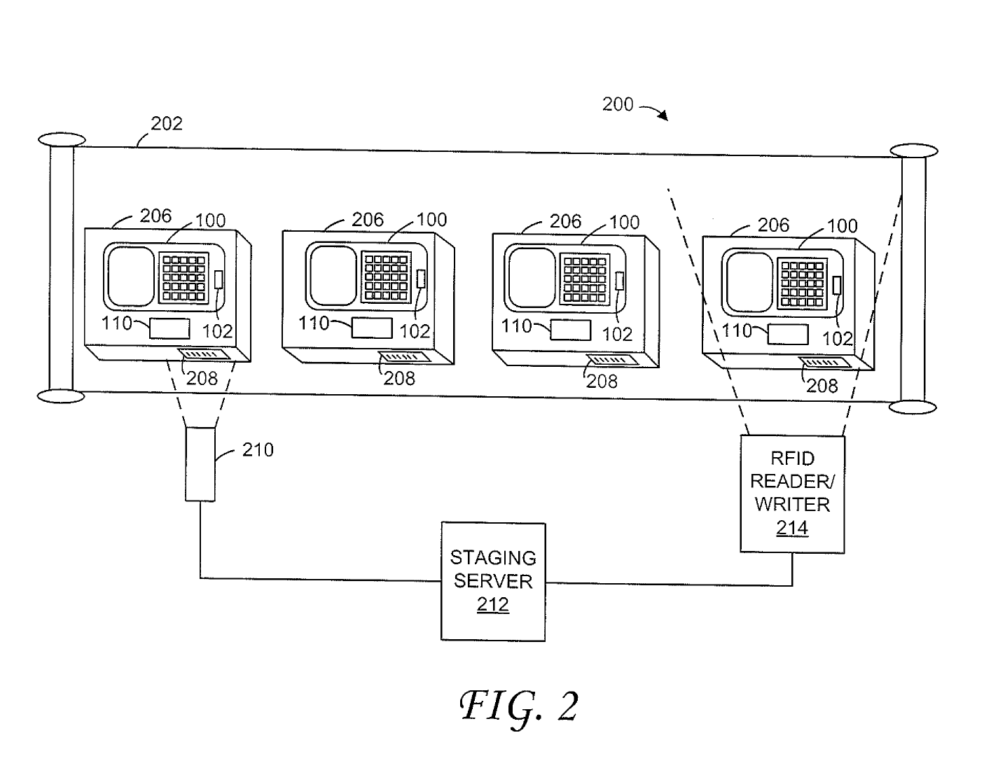

FIG. 2 illustrates a staging system 200 according to an exemplary embodiment. The staging system 200 includes a moving conveyor 202, such as a conveyor belt. Pre-staged mobile devices 100 that are packed in packaging 206 from the manufacturer can be positioned on the conveyor 202. The pre-staged mobile devices 100 each include an RFID tag 102. The RFID tags 102 can be embedded in the devices 100, or attached to the housing of the devices 100. In one embodiment, the RFID tags 102 are included with the packaging 206 containing the mobile devices 100.

The packaging 206 can include a barcode symbol 208 printed thereon. The barcode symbol 208 can contain the serial number of the mobile device 100 contained within the packaging 206. The barcode symbol 208 can be read by a barcode reader 210, such as a laser-based barcode scanner or an imager-based barcode scanner. Although the system 200 is shown with individual packages 206 on a conveyer 202, the system 200 can also be used with a pallet (not shown) loaded with individual packages 206. The pallet can include a barcode symbol that includes the serial numbers of each mobile device 100 contained within the individual packages 206. In another embodiment, multiple mobile devices 100 can be contained within each individual package 206.

The packaging 206 can also contain a battery 110 for the mobile device 110. The battery 110 is generally detached from the mobile device 100 when the mobile device 100 is packaged and shipped.

The staging system 200 can also include a staging server 212 that communicates with the barcode reader 210. The staging server 212 can communicate with the barcode reader 210 either wirelessly or through a wired connection. The staging server 212 can be a mobility services platform (MSP) server having a database and an MSP administrator.

In an exemplary embodiment, the staging server 212 is the central management system that coordinates staging for all devices in the network and ultimately manages all the devices following staging. Thus, the server 212 can be configured to provide the conventional manner of staging using the SMS messages over a network. The staging server 212 can be configured to stage a mobile device 100 that is connected to it through a wired connection, such as a wired cradle.

As will be discussed in further detail below, the server 212 can also generate staging profiles used to stage mobile devices. A database residing on the server 212 can store data for the network. For example, the database can store various staging profiles, identification and authentication data for electronic devices of the network, and other network data. An MSP administrator executing on the server can determine permission for data exchange such as controlling which end devices are allowed to receive or transmit data on the network. Furthermore, the MSP administrator can restrict whether the mobile device 100 is authorized to receive a particular staging profile.

The staging system 200 can also include a radio-frequency identification (RFID) reader/writer 214 that communicates with the staging server 212. The RFID reader/writer 214 can communicate with the staging server 212 either wirelessly or through a wired connection.

According to one embodiment, the mobile device 100 receives a staging profile stored in a memory of the staging server 212 through the RFID tag 102 associated with the mobile device 100. The RFID tag 102 associated with the mobile device 100 passes through a field of view of the RFID reader/writer 214. The RFID reader/writer 214 receives a predetermined staging profile from the staging server 212 and writes the predetermined staging profile to the RFID tag 102 associated with the mobile device 100. The predetermined staging profile is written to the RFID tag 102 while the battery 110 is detached from the mobile device 100.

The staging profile is written to the memory 106 (FIG. 1) of the mobile device 100 when the battery 110 is connected and the mobile device 100 is activated. For example, the RFID reader 103 of the mobile device 100 can be programmed to load the staging profile stored in the RFID tag 102 into the memory 106 of the mobile device 100. The processor 104 of the mobile device 100 can execute a software application that uses the staging profile to stage the mobile device 100.

In one embodiment, the same staging profile can be written to the RFID tags 102 associated with each of the mobile devices 100. In this embodiment, the barcode reader 210 and the barcode 208 containing the unique serial number are not required. In another embodiment, the barcode reader 210 and the barcode 208 containing the unique serial number are used to provide the staging system with control of the timing and sequencing for pre-staging mobile devices 100. For example, it might not be desirable to pre-stage all devices 100 simultaneously when multiple pallets of devices 100 are located within the field of view of the MD reader attached to the staging system.

Instead, it might be preferable to pre-stage devices 100 only as they are presented to the staging system in a particular order, such as via a conveyor. Thus, the ability to stage different devices 100 using different staging profiles does not depend on the presence of the barcode 208, since each device 100 is always identified uniquely and could be staged with different staging profiles. The presence of the barcode 208 is only required to control which devices 100 are staged and at what point in time.

The different staging profiles can be written to the RFID tags 102 associated with each of the mobile devices 100. As will be described in more detail herein, the unique serial number of each mobile device 100 can be used to associate the desired staging profile with the desired mobile device 100. The barcode 208 can include the unique serial number. In one embodiment, the staging profile can be encrypted prior to being written to each RFID tag 102. Only the mobile device 100 containing the correct key can decrypt the encrypted staging profile.

The staging server 212 is configured to transmit a selected staging profile to the RFID reader 214. As discussed above, the staging profile may be stored in a database containing various staging profiles within the staging server 214. Thus, the staging server 214 can retrieve the staging profile from the database.

In a first example, the mobile device 100 can be a new wireless mobile device. Thus, the mobile device 100 may not be properly configured to connect to any network such as an enterprise network. In another example, the mobile device 100 may be configured to connect to other networks but not configured to connect to the desired network. Thus, to properly be configured, the mobile device 100 is required to be staged.

As illustrated in FIG. 2, the mobile device 100 including the associated RFID tag 102 can be disposed within a field of view of the RFID reader/writer 214. Specifically, the RFID tag 102 may be in communication with the RFID reader/writer 214. It should be noted that the illustrated operating area of the RFID reader/writer 214 is only exemplary. Those skilled in the art will understand that there are various RFID reader/writer topologies in which the RFID tag 102 of the mobile device 100 may be capable of receiving a staging profile from the staging server 212.

A staging profile may be used to encapsulate everything to be performed during staging including all configurations to be applied to devices and all deployment to be performed by devices. As discussed above, the staging profiles may be stored in a database of the staging server 212.

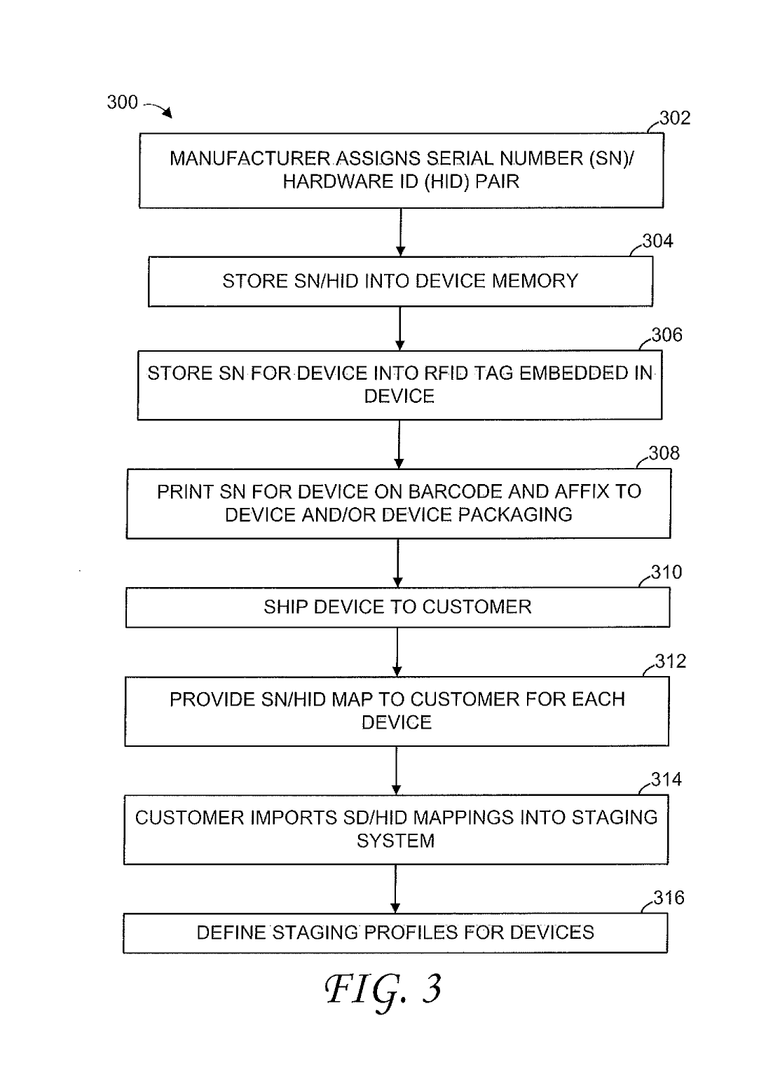

FIG. 3 illustrates a pre-staging process 300 for preparing the mobile device 100 (FIG. 1) for connection with a network according to an exemplary embodiment. In step 302, a manufacturer assigns a unique serial number (SN) and a unique hardware identifier (HID) to the mobile device 102. The unique hardware identifier is also known as a universally unique identifier (UUID). The SN for the device 102 is different than the HID for that device 102.

In step 304, the manufacturer stores the SN and the HID into the memory 106 of the mobile device 100. The SN and the HID are accessible to the processor 104 of the mobile device 100. The HID is not discoverable by any device external to the mobile device 100. In step 306, the SN is stored in the RFID tag 102 associated with the mobile device 100. In one embodiment, the SN stored in the RFID tag 102 is unalterable by an external device, including the RFID reader/writer 214 (FIG. 2). The HID for the mobile device 100 is not stored in the RFID tag 102 associated with the mobile device 100.

In step 308, the SN for the mobile device 100 can be printed as a barcode symbol 208 (FIG. 2) and affixed to the mobile device 100 and/or affixed to the packaging 206 of the mobile device 100. The barcode symbol 208 can be printed on an affixed label or can be printed directly to an external surface of the packaging 206.

The mobile device 100 is then shipped to a customer in step 310. The customer is provided a map correlating the SN and the HID for each mobile device 100 in step 312. The customer imports the SN/HID correlation map into the staging server 212 (FIG. 2) in step 314. The customer then defines one or more staging profiles for staging the mobile devices 100 (step 316). Each staging profile can be associated with each mobile device 100 through the unique SN of the mobile device 100. The staging profiles can be stored in a memory (e.g., database) of the staging server 212. In one embodiment, each mobile device 100 can be configured with a different staging profile. In another embodiment, each mobile device 100 can be configured with the same staging profile.

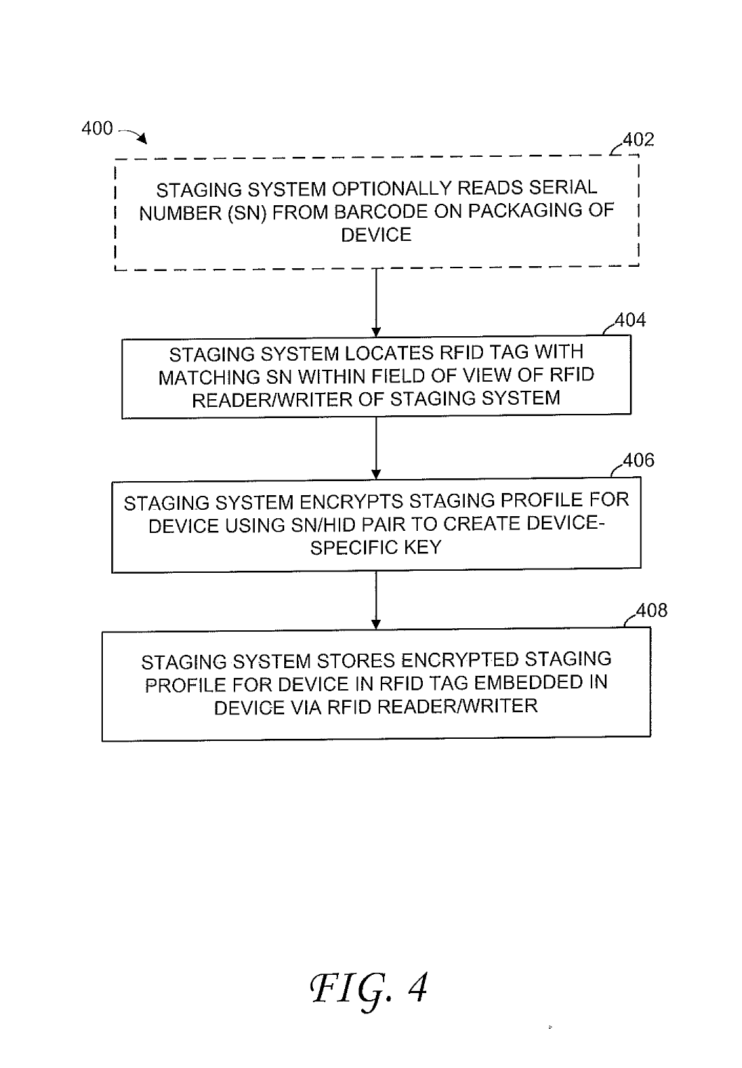

FIG. 4 illustrates a process 400 to prepare the staging server 212 (FIG. 2) for staging mobile devices 100 according to an exemplary embodiment. In optional step 402, a barcode scanner 210 (FIG. 2) reads the barcode symbol 208 containing the serial number (SN) of the corresponding mobile device 100. As previously described, optional step 402 is required to ensure that only desired mobile devices receive a staging profile from the staging system 200 (FIG. 2) and not those mobile devices having associated RFID tags that are simply present in the field of view of the RFID reader/writer 214. As previously described, one purpose of the presence of the barcode symbol 208 is to permit the staging system 200 to restrict which devices are stage and at what point in time.

In step 404, the serial number stored in the RFID tag 102 of the associated mobile device 100 is read by the RFID reader/writer 214 of the staging system 200. The staging server 212 locates a desired mobile device 100 by comparing the serial number from the barcode symbol 208 read in step 402 to a matching serial number stored in an associated RFID tag 102 of the mobile device 100.

In step 406, the staging server 212 encrypts a desired staging profile for the mobile device 100 by creating an encryption key using the unique SN and unique HID of the mobile device 100. Various encryption techniques known to skilled artisans can be used to encrypt the staging profile. Any suitable encryption technique can be used. A key that can be used to decrypt the encrypted staging profile is generated independently by the mobile device 100 based on the unique SN and unique HID. The mobile device 100 generates the key independently to ensure that the staging server 212 can be trusted (i.e., the staging server 212 possesses the unique SN and unique HID).

The staging server 212 stores the encrypted staging profile for the mobile device 100 in the associated RFID tag 102 in step 408. Specifically, the staging server 212 transmits the encrypted staging profile to the RFID reader/writer 214. The RFID reader/writer 214 writes the encrypted staging profile to the RFID tag 102 of the mobile device 100 when the RFID tag 102 is in range of the RFID reader/writer 214. In one embodiment, step 408 is performed when the mobile device 100 is deactivated and has not been removed from its original package 206.

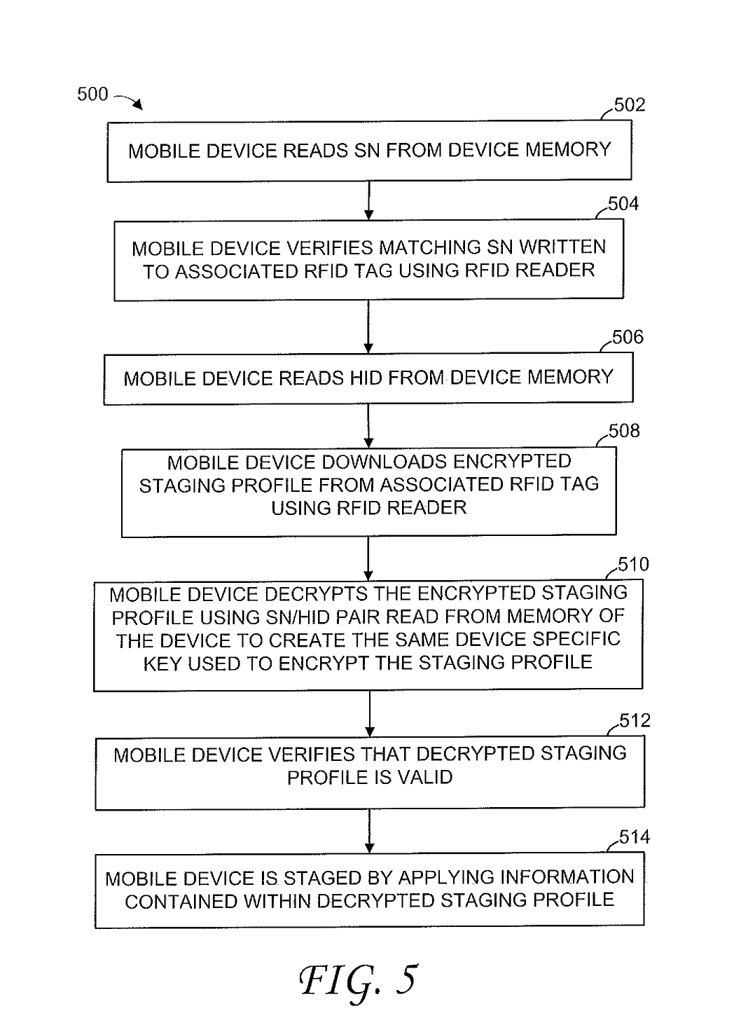

FIG. 5 illustrates a process 500 to prepare the mobile device 100 (FIG. 1) for staging according to an exemplary embodiment. In step 502, a software application executing on the mobile device 100 instructs the processor 104 to obtain the serial number of the mobile device 100 from the memory 106. The software application can be the client software associated with the mobility services platform (MSP) software executing on the staging server 212 (FIG. 2).

In step 502, the software application executing on the mobile device 100 verifies that the SN of the mobile device 100 residing in the memory 106 matches the SN residing in the RFID tag 102 associated with the mobile device 100. For example, the software application instructs the RFID reader 103 (FIG. 1) to read the SN from the RFID tag 102 and ignore all other RFID tags in range of the RFID reader 103. This ensures that the software application receives information from the correct RFID tag 102.

In step 502, the software application executing on the mobile device 100 retrieves the HID of the mobile device 100 residing in the memory 106. Using the RFID reader 103, the software application then copies the encrypted staging profile from the RFID tag 102 associated with the mobile device 100 (step 508) to the memory 106.

The software application then decrypts the encrypted staging profile using the same device-specific key that was generated from the SN/HID data residing in the memory 106 of the mobile device 100 (step 510). As previously described, the key is independently generated by the mobile device 100 based on the unique SN and the unique HID. This ensures that if the mobile device 100 can decrypt the encrypted staging profile read from the RFID tag 102, then the data written into the RFID tag 102 must have come from a trusted source, namely a source that possessed the unique SN and the unique HID and independently generated the same key. Thus, in one embodiment, the staging system uses symmetric cryptography and the generated key is a symmetric key that can be used to encrypt and decrypt the staging profile.

The software application then verifies that the decrypted staging profile is valid (step 512). For example, after the staging information is decrypted, it can be verified as being a valid staging profile through analysis of the data contained in the staging profile. If the data is encrypted with the incorrect key, then any decrypted staging profile will not contain verifiable data. The software application can verify the data to establish trust with the staging server, since it is the only way the software application can know if the decryption actually “worked” and hence that a key generated based on the unique SN and the unique HID was possessed by the staging server. In alternate embodiments, verification could be accomplished using any suitable technique including data format, cyclic redundancy check (CRC) or checksum, for example. Finally, the software application stages the mobile device 100 by applying information contained within the decrypted staging profile (step 514).

Although the processes described in FIG. 3, FIG. 4, and FIG. 5 involve a sequence of steps, it should be noted that the order of the steps in each process may be changed without departing from the scope of the invention. Additionally, once the staging profile is written to the RFID tag 102, the staging process described herein can be performed automatically by the mobile device without user intervention.

In other embodiments, a mobile device including a RFID reader/writer can act as a staging server and can write encrypted staging data to the RFID tags associated with other mobile devices to be staged. In one embodiment, once the encrypted staging profile is written to the associated RFID tag, the mobile device can be programmed to automatically stage itself, securely, upon installation of its battery. In other embodiments, additional information, such as device model or operating system version, can be stored in the associated RFID tag to provide capability to stage the mobile device differently, based on such additional information.

The exemplary embodiments provide for the staging of a mobile device in a simpler, quicker, more reliable, and cost efficient manner. Staging using the RFID technology described herein allows the administrator of the mobile devices to stage multiple mobile devices prior to removing the mobile devices from the original packaging.

Those skilled in the art will understand that the above described exemplary embodiments may be implemented in any number of manners, including, as a separate software module, as a combination of hardware and software, etc. For example, the staging applications of the mobile device and/or the staging server may be programs containing lines of code that, when compiled, may be executed on a processor.

In general, the processor can include processing logic configured to carry out the functions, techniques, and processing tasks associated with the operation of the mobile device. Furthermore, the steps of a method or algorithm described in connection with the embodiments disclosed herein may be embodied directly in hardware, in firmware, in a software module executed by the processor, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus described herein. The non-processor circuits may include, but are not limited to, a radio receiver, a radio transmitter, signal drivers, clock circuits, power source circuits, and user input devices. As such, these functions may be interpreted as steps of a method to perform the mobile device staging described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A mobile device comprising:
a processor executing a software application;
a memory storing a unique hardware identifier for the mobile device, wherein the unique hardware identifier is readable by the software application and unreadable by a system external to the mobile device; and
a radio frequency identification (RFID) tag associated with the mobile device storing a unique serial number that is readable by a staging system external to the mobile device and by the software application; and
the staging system encrypting a staging profile using both the unique serial number and the unique hardware identifier to create a device-specific key and writing the encrypted staging profile to the RFID tag.

2. The mobile device of claim 1, wherein the unique hardware identifier for a mobile device is provided to the staging system by a device manufacturer separately from the mobile device.

3. The mobile device of claim 1, further comprising an RFID tag reader coupled to the processor.

4. The mobile device of claim 3, wherein the RFID tag reader is one of integrated and removably attached.

5. The mobile device of claim 1, wherein the unique serial number is unalterable by an external device.

6. The mobile device of claim 1, further comprising a battery removably coupled to the mobile device.

7. The mobile device of claim 6, wherein the staging profile is writable to the RFID tag when the battery is uncoupled from the mobile device.

8. The mobile device of claim 1, further comprising a package for containing the mobile device, the unique serial number being applied to the package in the form of a barcode symbol.

9. The mobile device of claim 8, wherein the staging system comprises a barcode reader configured to read the barcode symbol, the staging system comparing the serial number from the barcode symbol with the serial number from the RFID tag associated with the mobile device.

10. The mobile device of claim 1, wherein the staging system comprises an RFID writer configured to write the encrypted staging profile to the RFID tag associated with the mobile device when the mobile device is positioned in range of the RFID writer.

11. A method for staging a mobile device comprising:
storing a unique hardware identifier in a memory of the mobile device that is readable by a software application executing on a processor of the mobile device and unreadable by a system external to the mobile device;
reading a unique serial number stored in a radio frequency identification (RFID) tag associated with the mobile device;
encrypting a staging profile using both the unique serial number and the unique hardware identifier to create a device-specific key;
locating the mobile device having the RFID tag with the unique serial number;
writing the encrypted staging profile to the RFID tag;
decrypting the encrypted staging profile using the device-specific key; and
staging the mobile device by applying information in the decrypted staging profile to the mobile device.

12. The method of claim 11, verifying an authenticity of the decrypted staging profile.

13. The method of claim 11, further comprising providing the unique hardware identifier to a staging system.

14. The method of claim 11, wherein the unique serial number stored in the RFID tag is unalterable by an external device.

15. The method of claim 11, further comprising applying a barcode symbol including the serial number on an external surface of a package containing the mobile device.

16. The method of claim 15, further comprising reading the barcode symbol and comparing the serial number from the barcode symbol with the serial number from the RFID tag associated with the mobile device.

17. The method of claim 15, further comprising writing the encrypted staging profile to the RFID tag associated with the mobile device when the mobile device is positioned in range of a RFID writer.

18. A staging arrangement comprising:
a mobile device comprising:
a processor executing a software application;
a memory storing a unique hardware identifier for the mobile device, wherein the unique hardware identifier is readable by the software application and unreadable by a system external to the mobile device; and
a radio frequency identification (RFID) tag associated with the mobile device storing a unique serial number that is readable by a staging system external to the mobile device and the software application; and
a staging system comprising:
a staging device encrypting a staging profile using both the unique serial number and the unique hardware identifier to create a device-specific key, the staging device writing the encrypted staging profile to the RFID tag associated with the mobile device.

19. The staging arrangement of claim 16, wherein the unique hardware identifier for a mobile device is provided to the staging system by a device manufacturer separately from the mobile device.

20. The staging arrangement of claim 16, wherein the unique serial number is unalterable by an external device.

21. The staging arrangement of claim 16, further comprising a battery removably coupled to the mobile device.

22. The staging arrangement of claim 16, further comprising a package for containing the mobile device, the unique serial number being applied to the package in the form of a barcode symbol.

23. The staging arrangement of claim 22, wherein the staging system further comprises a barcode reader configured to read the barcode symbol, the staging system comparing the serial number from the barcode symbol with the serial number from the RFID tag associated with the mobile device.

24. The staging arrangement of claim 16, wherein the staging system further comprises an RFID writer configured to write the encrypted staging profile to the RFID tag associated with the mobile device when the mobile device is positioned in range of the RFID writer.
